(19) United States
(12) Patent Application Publication
(10) Pub. No.: US 2026/0071378 A1
(43) Pub. Date: Mar. 12, 2026

(54) STEAM GENERATION APPARATUS AND IRONING APPARATUS

(71) Applicant: SHEN ZHEN INTEGRATION SMART CO., LTD, Shenzhen (CN)

(72) Inventors: LIANGHONG LI, Dongguan City (CN); JIAN YANG, Shenzhen (CN); TAO YANG, Shenzhen (CN)

(21) Appl. No.: 19/324,053

(22) Filed: Sep. 9, 2025

(30) Foreign Application Priority Data
Sep. 10, 2024 (CN) 202422224024.7
Oct. 8, 2024 (CN) 202422427856.9

(51) Int. Cl. D06F 75/24; D06F 75/20; H05B 3/22

(52) U.S. Cl. CPC D06F 75/24; D06F 75/20; H05B 3/22

(57) ABSTRACT

A steam generation apparatus includes an ironing base plate and a heating tube assembly and a connecting water pipe that are both disposed on the ironing base plate, wherein a water inlet is disposed at an end, farther away from the connecting water pipe, of the heating tube assembly, a steam outlet is disposed in the ironing base plate, and the heating tube assembly, the connecting water pipe and the ironing base plate communicate in sequence, so that the water inlet and the steam outlet communicate; the heating tube assembly includes a coated heating tube, and a blocking structure is disposed inside the heating tube assembly, so that water flowing in through the water inlet is blocked by the blocking structure when flowing inside the heating tube assembly.

### CROSS REFERENCE OF RELATED APPLICATION

This application is a non-provisional application that claims priority under 35U.S.C. § 119 to China application number CN202422224024.7, filing date Sep. 10, 2024, and China application number CN202422427856.9, filing date Oct. 8, 2024, wherein the entire content of which is expressly incorporated herein by reference.

### BACKGROUND OF THE PRESENT INVENTION

### Field of the Invention

The present invention relates to ironing equipment, and more particularly to a steam generation apparatus and an ironing apparatus.

### Description of Related Arts

The ironing apparatuses are configured to iron clothes to flatten the clothes. Conventional ironing apparatuses include electric irons, steam brushes, garment steamers, and the like.

A steam generation apparatus of the existing garment steamer on the market usually includes a cover plate with an inlet, a heating body with a heating tube inside, and an ironing base plate with an outlet. A partition plate with through holes inside the heating body is used to divide the heating body into a first cavity and a second cavity. The cover plate and the ironing base plate are disposed to cover the first cavity and the second cavity respectively. Water enters the first cavity via the cover plate and then flows into the second cavity via the through holes. During this process, water is heated by the heating body to become steam to be finally discharged through the outlet of the ironing base plate.

However, the steam generation apparatus of the conventional garment steamer only has two cavities, water stays in the steam generation apparatus for a relatively short time, and as a result, water is likely to be insufficiently heated, and a mixture of steam and water is finally discharged via the outlet of the ironing base plate, which affects use effects.

A technical core of the garment steamers lies in their steam generation apparatuses. Steam generation apparatuses using nano-coated heating tubes for heating in the garment steamers have emerged by now.

However, when the existing nano-coated heating tube on the market is full of water, there is a relatively large volume of water, a flow velocity of water is increased, and therefore, water stays inside the nano-coated heating tube for a relatively short time and is likely to be heated for insufficient time. As a result, a mixture of steam and water is discharged from a steam outlet of the steam generation apparatus, which affects user experience.

Currently, conventional steam generation apparatuses usually use electric heating tubes for heating. The electric heating tubes are sandwiched between two metal castings in which flow channels are disposed. The three components are die-cast into an integrated heating pot. In addition, flow channels are respectively disposed on outer sides of the two metal castings, and rear covers and ironing base plates are respectively disposed to cover the two flow channels, thereby forming a five-layer structured steam generation apparatus.

Due to the relatively great thickness of the electric heating tube, a conventional heating pot formed in the foregoing method has a relatively large volume, resulting in a large volume of the conventional steam generation apparatus.

### SUMMARY OF THE PRESENT INVENTION

In view of this, it is necessary to provide a steam generation apparatus that can resolve the foregoing problems.

In addition, it is further necessary to provide an ironing apparatus including the foregoing steam generation apparatus.

A steam generation apparatus is provided, including a cover plate, a heating body, a heating element, a heat conduction plate and an ironing base plate;
the heating element is connected to the heating body, the heating body includes a cylindrical side wall and a partition structure, the partition structure divides the cylindrical side wall into a first annular side wall connected to the cover plate and a second annular side wall connected to the ironing base plate, and the partition structure, the first annular side wall and the cover plate enclose a first cavity;
the heat conduction plate is disposed inside the heating body, an outer circumference of the heat conduction plate is connected to an inner wall of the second annular side wall, the partition structure, the second annular side wall and the heat conduction plate enclose a second cavity, and the heat conduction plate, the second annular side wall and the ironing base plate enclose a third cavity; and
the cover plate is provided with an inlet communicating with the first cavity, the partition structure is provided with a first through hole connecting the first cavity to the second cavity, the heat conduction plate is provided with a second through hole connecting the second cavity to the third cavity, and the ironing base plate is provided with an outlet communicating with the third cavity.

In an embodiment, a step is disposed on the inner wall of the second annular side wall and the heat conduction plate is disposed on the step.

In an embodiment, the step is in an annular shape to match the outer circumference of the heat conduction plate.

In an embodiment, the outer circumference of the heat conduction plate and the step are fixed and sealed together via an adhesive.

In an embodiment, the heat conduction plate is a metal plate.

In an embodiment, a first flow channel is disposed on a surface, facing toward the cover plate, of the partition structure, and the inlet and the first through hole correspond to two openings of the first flow channel respectively.

In an embodiment, a second flow channel is disposed on a surface, facing toward the heat conduction plate, of the partition structure, and the first through hole and the second through hole correspond to two openings of the second flow channel respectively.

In an embodiment, the heating body is an integrally formed die-cast part.

In an embodiment, the heating element is disposed inside the partition structure and the heating element and the heating body are integrally formed via die casting.

An ironing apparatus is provided, including the foregoing steam generation apparatus.

As for the steam generation apparatus in the present invention, the heat conduction plate is disposed inside the heating body, and the outer circumference of the heat conduction plate is connected to the inner wall of the second annular side wall, so that the heat conduction plate, the second annular side wall and the ironing base plate enclose the third cavity. When the steam generation apparatus is being used, water flows into the first cavity through the inlet, then flows into the second cavity through the first through hole, further flows into the third cavity through the second through hole, and finally becomes steam in the third cavity, to be discharged through the outlet.

Compared with conventional steam generation apparatuses, the steam generation apparatus in the present invention has three cavities, namely the first cavity, the second cavity and the third cavity, and as a result, water stays in the steam generation apparatus in the present invention for a longer period of time to be fully heated, so that steam is finally discharged through the outlet of the ironing base plate.

In addition, because a heating body of the conventional steam generation apparatus is usually produced via a die-casting process, at most two cavities can be formed in the heating body. However, one more cavity can be divided by adding only one such heat conduction plate to the steam generation apparatus in the present invention, that is, disposing the heat conduction plate inside the heating body. In addition, the heating body of the steam generation apparatus in the present invention can be produced still by using an original die-casting process. An overall shape of the heating body remains basically unchanged, and only simple improvements need to be made to the internal structure.

A steam generation apparatus is provided, including an ironing base plate and a heating tube assembly and a connecting water pipe that are both disposed on the ironing base plate, where a water inlet is disposed at an end, farther away from the connecting water pipe, of the heating tube assembly, a steam outlet is disposed in the ironing base plate, and the heating tube assembly, the connecting water pipe and the ironing base plate communicate in sequence, so that the water inlet and the steam outlet communicate; and

The heating tube assembly includes a coated heating tube, and a blocking structure is disposed inside the heating tube assembly, so that water flowing in through the water inlet is blocked by the blocking structure when flowing inside the heating tube assembly.

In an embodiment, the heating tube assembly further includes a heat conduction water pipe, the coated heating tube is sleeved outside the heat conduction water pipe, the water inlet is disposed at an end, farther away from the connecting water pipe, of the heat conduction water pipe, and the heat conduction water pipe, the connecting water pipe and the ironing base plate communicate in sequence.

In an embodiment, a side wall of the coated heating tube and a side wall of the connecting water pipe are both fitted onto the ironing base plate and the ironing base plate is a heat conduction plate; and
the coated heating tube includes a main tube and a heating layer disposed on an outer side of the main tube, the heating layer is in direct contact with the ironing base plate, and the heating layer is a nano coating or a printed circuit layer.

In an embodiment, an end, farther away from the heat conduction water pipe, of the connecting water pipe is a flat structure, a flat surface of the flat structure is fitted onto the ironing base plate, and a through hole fitting the steam outlet is disposed in the flat surface of the flat structure.

In an embodiment, the heat conduction water pipe is a metal pipe.

In an embodiment, there are at least three heat conduction water pipes, the at least three heat conduction water pipes are all sleeved inside the coated heating tube, and an end, closer to the connecting water pipe, of each of the at least three heat conduction water pipes and the connecting water pipe communicate.

In an embodiment, the blocking structure is a granular or filamentous blocking object filled inside the heat conduction water pipe, and/or the blocking structure is a concave-convex structure disposed on the inner wall of the heat conduction water pipe.

In an embodiment, the blocking object is metal particles or metal wires.

In an embodiment, a filter screen is further disposed at an end, closer to the connecting water pipe, of the heat conduction water pipe.

An ironing apparatus is provided, including the foregoing steam generation apparatus.

The blocking structure is disposed inside the heating tube assembly of the steam generation apparatus in the present invention, and therefore, water flowing in through the water inlet is blocked by the blocking structure when flowing inside the heating tube assembly, which further prolongs residence time of water in the coated heating tube and extends heating duration, to ensure that almost only steam is discharged through the steam outlet, thereby enhancing user experience.

A steam generation apparatus is provided, including an ironing base plate and a heating plate stacked and fixed on the ironing base plate, where the heating plate includes a heat conduction substrate and a heating circuit layer disposed on the heat conduction substrate; and
a first flow channel is disposed in a surface, closer to the heating plate, of the ironing base plate, multiple steam outlets penetrating through the ironing base plate are disposed at an end of the first flow channel, and the ironing base plate and the heating plate enclose a first cavity matching a shape of the first flow channel.

In an embodiment, the heating circuit layer is disposed on a surface, farther away from the ironing base plate, of the heat conduction substrate, and an end of the first flow channel is located in a central area of the ironing base plate.

In an embodiment, a water inlet is disposed in a side surface of the ironing base plate or in the heating plate.

In an embodiment, the steam generation apparatus further includes a first water pipe disposed in the first cavity, the first water pipe is accommodated in the first flow channel, multiple first outlets matching the multiple steam outlets are disposed at a tail end of the first water pipe, the multiple first outlets are corresponding to and communicate with the multiple steam outlets, a first inlet matching the water inlet is disposed at a head end of the first water pipe, and the first inlet and the water inlet communicate.

In an embodiment, the steam generation apparatus further includes a back plate, and the back plate, the heating plate and the ironing base plate are sequentially stacked and fixed together; and
a second flow channel is disposed in a surface, closer to the heating plate, of the back plate, a communication port is disposed in the heat conduction substrate, the second flow channel and the first flow channel communicate through the communication port, the back plate and the heating plate enclose a second cavity matching a shape of the second flow channel, and a water inlet penetrating through the back plate is disposed at the head end of the second flow channel.

In an embodiment, the steam generation apparatus further includes a first water pipe disposed in the first cavity and a second water pipe disposed in the second cavity, the first water pipe is accommodated in the first flow channel, the second water pipe is accommodated in the second flow channel, and the water inlet, the second water pipe, the communication port, the first water pipe, and the steam outlet communicate in sequence.

In an embodiment, a first inlet is disposed in a surface, facing toward the heating plate, of the head end of the first water pipe, a second inlet is disposed in a surface, facing toward the heating plate, of a tail end of the second water pipe, and the first inlet, the communication port and the second outlet communicate in sequence.

In an embodiment, multiple first outlets matching the multiple steam outlets are disposed at a tail end of the first water pipe, and the multiple first outlets are corresponding to and communicate with the multiple steam outlets; and
the water inlet is located in a surface, farther away from the heating plate, of the back plate, a second inlet is disposed in a surface, farther away from the heating plate, of a head end of the second water pipe, and the second inlet and the water inlet communicate.

In an embodiment, the back plate, the heating plate, the ironing base plate, the first water pipe, and the second water pipe are all metal parts.

An ironing apparatus is provided, including the foregoing steam generation apparatus.

The steam generation apparatus in the present invention includes the heating plate and the ironing base plate stacked and fixed together. The ironing base plate and the heating plate enclose a first cavity matching a shape of the first flow channel. After being injected, water can be heated into steam by the heating plate.

Compared with conventional steam generation apparatuses, the steam generation apparatus in the present invention uses the heating plate for heating. The heating plate and the ironing base plate are stacked. In addition, because the heating plate is thinner than conventional electric heating tubes, an overall volume of the steam generation apparatus in the present invention is smaller.

### BRIEF DESCRIPTION OF THE DRAWINGS

FIG. 1 is a schematic view of a three-dimensional structure of a steam generation apparatus viewed from a direction according to an embodiment.

FIG. 2 is a schematic view of a three-dimensional structure of a steam generation apparatus in FIG. 1 viewed from another direction.

FIG. 3 is a schematic exploded view of a partial structure of a steam generation apparatus in FIG. 1 viewed from a direction.

FIG. 4 is a schematic exploded view of a partial structure of a steam generation apparatus in FIG. 1 viewed from another direction.

FIG. 5 is a schematic exploded view of a structure of a steam generation apparatus in FIG. 1 viewed from another direction.

FIG. 6 is a schematic view of a three-dimensional structure of a steam generation apparatus viewed from a direction according to another embodiment.

FIG. 7 is a schematic view of a three-dimensional structure of the steam generation apparatus in FIG. 6 viewed from another direction.

FIG. 8 is a schematic exploded view of a partial structure of the steam generation apparatus in FIG. 6 viewed from a direction.

FIG. 9 is a schematic exploded view of a partial structure of the steam generation apparatus in FIG. 6 viewed from another direction.

FIG. 10 is a schematic enlarged view of a cross section of a heat conduction water pipe of the steam generation apparatus in FIG. 6.

FIG. 11 is a schematic view of a three-dimensional structure of a steam generation apparatus viewed from a direction according to another embodiment.

FIG. 12 is a schematic view of a three-dimensional structure of the steam generation apparatus in FIG. 11 viewed from another direction.

FIG. 13 is a schematic structural exploded view of the steam generation apparatus in FIG. 11 viewed from a direction.

FIG. 14 is a schematic structural exploded view of the steam generation apparatus in FIG. 11 viewed from another direction.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

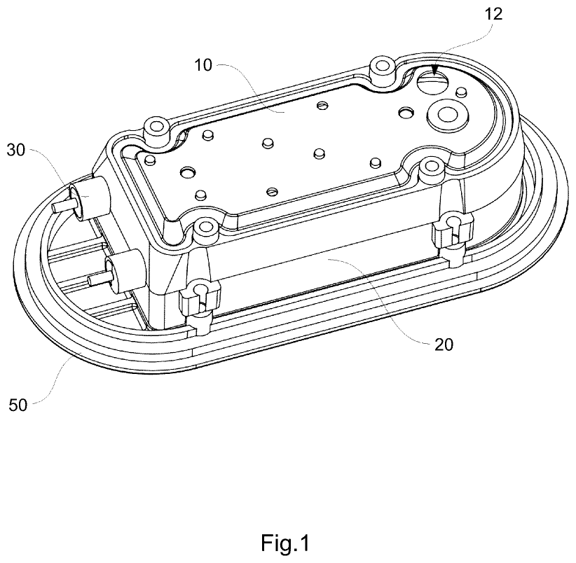

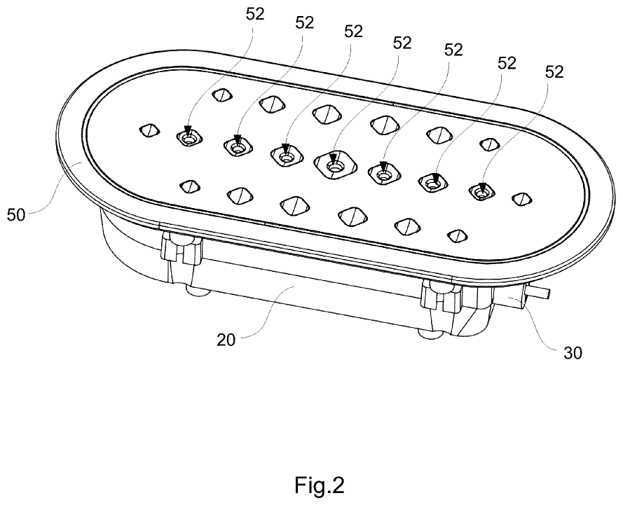

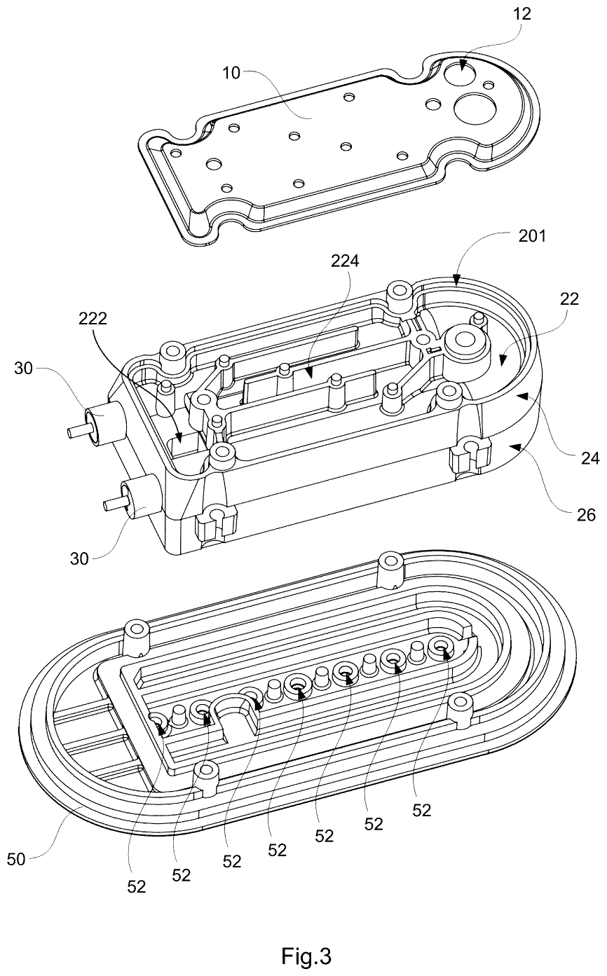

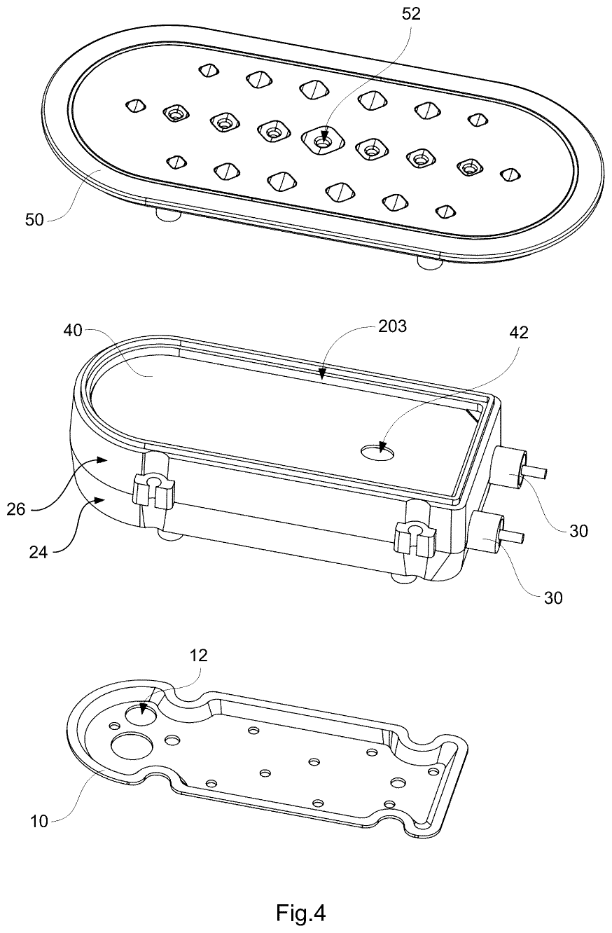

With reference to FIG. 1 to FIG. 5, the present invention discloses a steam generation apparatus according to an embodiment, including a cover plate 10, a heating body 20, a heating element 30, a heat conduction plate 40 and an ironing base plate 50.

The heating element 30 is connected to the heating body 20, the heating body 20 includes a cylindrical side wall and a partition structure 22, the partition structure 22 divides the cylindrical side wall into a first annular side wall 24 connected to the cover plate 10 and a second annular side wall 26 connected to the ironing base plate 50, and the partition structure 22, the first annular side wall 24 and the cover plate 10 enclose a first cavity 201.

The heat conduction plate 40 is disposed inside the heating body 20, an outer circumference of the heat conduction plate 40 is connected to an inner wall of the second annular side wall 26, the partition structure 22, the second annular side wall 26 and the heat conduction plate 40 enclose a second cavity 202, and the heat conduction plate 40, the second annular side wall 26 and the ironing base plate 50 enclose a third cavity 203.

The cover plate 10 is provided with an inlet 12 communicating with the first cavity 201, the partition structure 22 is provided with a first through hole 222 connecting the first cavity 201 to the second cavity 202, the heat conduction plate 40 is provided with a second through hole 42 connecting the second cavity 202 to the third cavity 203, and the ironing base plate 50 is provided with an outlet 52 communicating with the third cavity 203.

As for the steam generation apparatus in the present invention, the heat conduction plate 40 is disposed inside the heating body 20, and the outer circumference of the heat conduction plate 40 is connected to the inner wall of the second annular side wall 26, so that the heat conduction plate 40, the second annular side wall 26 and the ironing base plate 50 enclose the third cavity 203. When the steam generation apparatus is being used, water flows into the first cavity 201 through the inlet 12, then flows into the second cavity 202 through the first through hole 222, further flows into the third cavity 203 through the second through hole 42, and finally becomes steam in the third cavity 203, to be discharged through the outlet 52.

Compared with conventional steam generation apparatuses, the steam generation apparatus in the present invention has three cavities, namely the first cavity 201, the second cavity 202 and the third cavity 203, and as a result, water stays in the steam generation apparatus in the present invention for a longer period of time to be fully heated, so that steam is finally discharged through the outlet 52 of the ironing base plate 50.

In addition, because a heating body of the conventional steam generation apparatus is usually produced via a die-casting process, at most two cavities can be formed in the heating body. However, one more cavity can be separated by adding only one such heat conduction plate 40 to the steam generation apparatus in the present invention, that is, disposing the heat conduction plate 40 inside the heating body 20. In addition, the heating body 20 of the steam generation apparatus in the present invention can be produced still by using an original die-casting process. An overall shape of the heating body 20 remains basically unchanged, and only simple improvements need to be made to the internal structure.

With reference to the accompanying drawings, in this embodiment, there are multiple outlets 52, and the multiple outlets 52 are arranged in a row.

In another embodiment, the number of outlets 52 and specific arrangement of the outlets 52 may be set based on an actual need.

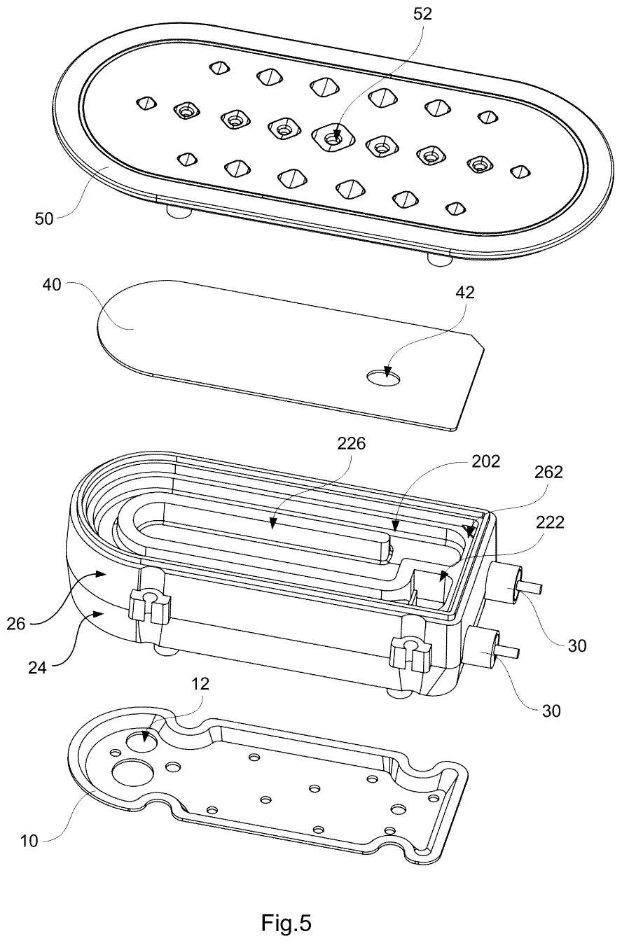

Specifically, with reference to FIG. 5, a step 262 is disposed on the inner wall of the second annular side wall 26 and the heat conduction plate 40 is disposed on the step 262.

When the heating body 20 is produced via the die-casting process, a step 262 can be formed on the inner wall of the second annular side wall 26 without complicating the process.

Preferably, in this embodiment, step 262 is in an annular shape to match the outer circumference of the heat conduction plate 40.

Specifically, in this embodiment, the outer circumference of the heat conduction plate 40 and the step 262 are fixed and sealed together via an adhesive.

In this embodiment, with reference to FIG. 5, the step 262 and the heat conduction plate 40 are respectively provided with mutually corresponding foolproof chamfers.

Preferably, in this embodiment, the heat conduction plate 40 is a metal plate. The metal plate is easy to manufacture and has good thermal conductivity.

More preferably, in this embodiment, the heat conduction plate 40 is an aluminum plate or an aluminum alloy plate. On one hand, the aluminum plate or the aluminum alloy plate is relatively light; on the other hand, the aluminum plate or the aluminum alloy plate has very excellent thermal conductivity.

Specifically, in this embodiment, a first flow channel 224 is disposed on a surface, facing toward the cover plate 10, of the partition structure 22, and the inlet 12 and the first through hole 222 correspond to two openings of the first flow channel 224 respectively.

Specifically, in this embodiment, a second flow channel 226 is disposed on a surface, facing toward the heat conduction plate 40, of the partition structure 22, and the first through hole 222 and the second through hole 42 correspond to two openings of the second flow channel 226 respectively.

Specifically, when the steam generation apparatus in the present invention is being used, water flows into the first flow channel 224 inside the first cavity 201 through the inlet 12 and flows along the first flow channel 224 until the first through hole 222, then flows into the second flow channel 226 inside the second cavity 202 through the first through hole 222 and flows through the second flow channel 226 until the second through hole 42, further flows into the third cavity 203 through the second through hole 42, and finally becomes steam in the third cavity 203, to be discharged through the outlet 52.

Preferably, in this embodiment, the heating body 20 is an integrally formed die-cast part.

With reference to the accompanying drawings, in this embodiment, the heating element 30 is disposed inside the partition structure 22 and the heating element 30 and the heating body 20 are integrally formed via die casting. With such a configuration, not only water can be better heated in both the first cavity 201 and the second cavity 202, but also the steam generation apparatus is more convenient to produce.

Specifically, in this embodiment, the heating element 30 is a heating coil. An annular hole is provided inside the partition structure 22, and the heating element 30 is accommodated in the annular hole.

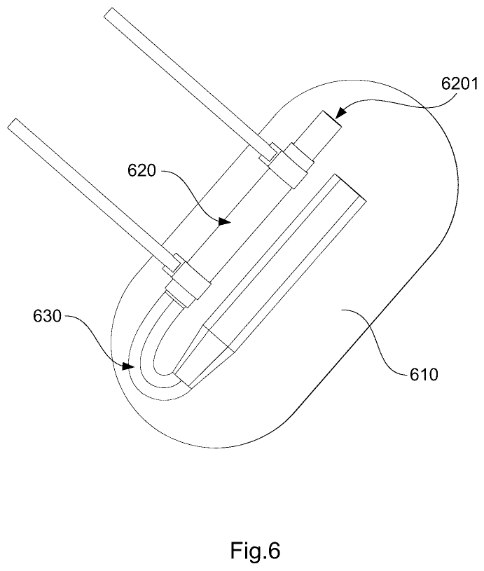

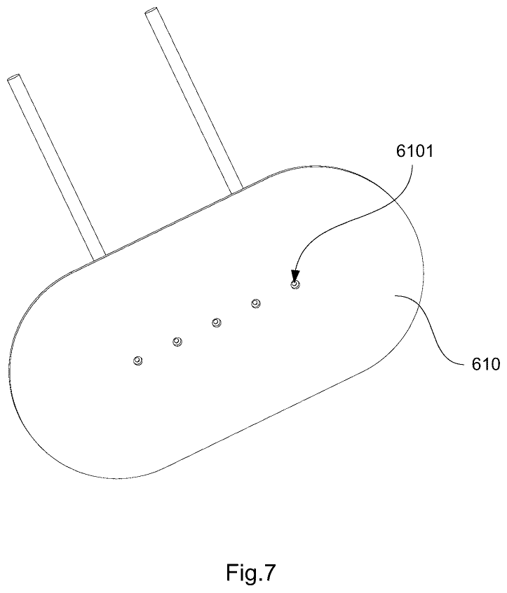

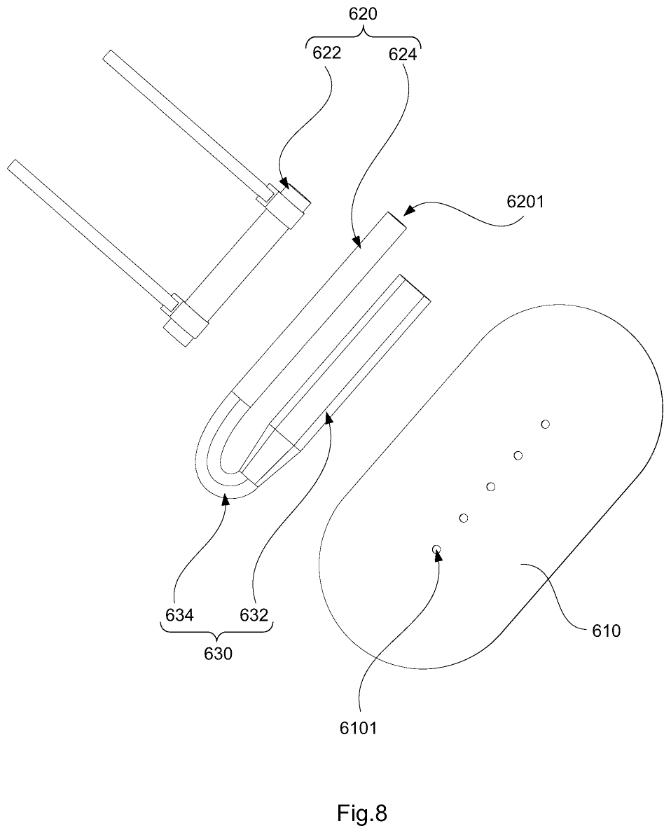

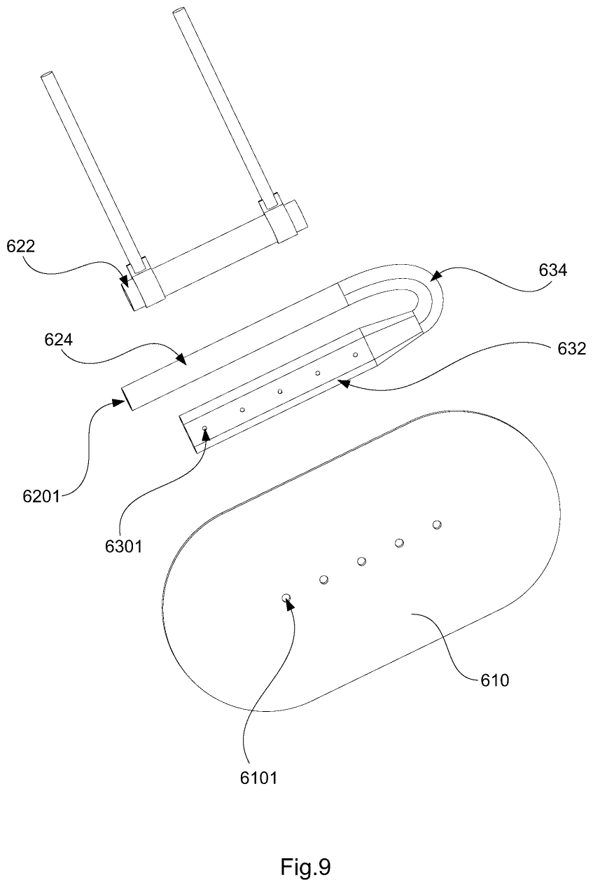

With reference to FIG. 6 to FIG. 9, the present invention discloses a steam generation apparatus according to an embodiment, including an ironing base plate 610 and a heating tube assembly 620 and a connecting water pipe 630 that are both disposed on the ironing base plate 610, where a water inlet 6201 is disposed at an end, farther away from the connecting water pipe 630, of the heating tube assembly 620, a steam outlet 6101 is disposed in the ironing base plate 610, and the heating tube assembly 620, the connecting water pipe 630 and the ironing base plate 610 communicate in sequence, so that the water inlet 6201 and the steam outlet 6101 communicate.

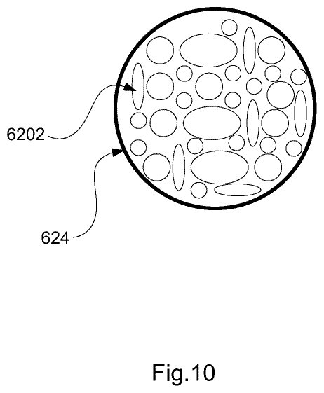

With reference to FIG. 10, in this embodiment, the heating tube assembly 620 includes a coated heating tube 622, and a blocking structure 6202 is disposed inside the heating tube assembly 620, so that water flowing in through the water inlet 6201 is blocked by the blocking structure 6202 when flowing inside the heating tube assembly 620.

The blocking structure is disposed inside the heating tube assembly 620 of the steam generation apparatus in the present invention, and therefore, water flowing in through the water inlet 6201 is blocked by the blocking structure 6202 when flowing inside the heating tube assembly 620, which further prolongs residence time of water in the coated heating tube 622 and extends heating duration, to ensure that almost only steam is discharged through the steam outlet 6101, thereby enhancing user experience.

It should be noted that, in this embodiment, when being actually used, the steam generation apparatus further includes a rear shell covering the ironing base plate 610. The rear shell and the ironing base plate 610 enclose an accommodating cavity, and both the heating tube assembly 620 and the connecting water pipe 630 are disposed in the accommodating cavity.

Preferably, in this embodiment, the heating tube assembly 620 further includes a heat conduction water pipe 624, the coated heating tube 622 is sleeved outside the heat conduction water pipe 624, the water inlet 6201 is disposed at an end, farther away from the connecting water pipe 630, of the heat conduction water pipe 624, and the heat conduction water pipe 624, the connecting water pipe 630 and the ironing base plate 610 communicate in sequence.

With reference to FIG. 10, specifically, in this embodiment, the blocking structure 6202 is disposed inside the heat conduction water pipe 624. This is mainly because the coated heating tube 622 is generally a standard member, and it is relatively costly to dispose the blocking structure 6202 inside the coated heating tube.

In another embodiment, the heat conduction water pipe 624 may alternatively be omitted and the blocking structure 6202 may be directly disposed inside the coated heating tube 622.

In addition, as a standard member, the coated heating tube 622 has a relatively great diameter, and as a result, when the coated heating tube 622 is full of water, there is an excessive amount of water, and it is difficult to sufficiently heat water. The heat conduction water pipe 622 is sleeved inside the coated heating tube 622, and the heat conduction water pipe 622 has a smaller diameter than the coated heating tube 622, so that there is a smaller amount of water when the heat conduction water pipe 622 is full of water, thereby further ensuring sufficient heating.

Herein, it should be noted that the water pipe inside the steam generation apparatus needs to stay full of water to avoid steam backflow.

Preferably, with reference to the accompanying drawings, in this embodiment, a side wall of the coated heating tube 622 and a side wall of the connecting water pipe 630 are both fitted onto the ironing base plate 610 and the ironing base plate 610 is a heat conduction plate.

In addition, in this embodiment, the coated heating tube 622 includes a main tube and a heating layer disposed on an outer side of the main tube, and the heating layer is in direct contact with the ironing base plate 610, so that the heating layer heats the ironing base plate 610 more easily.

Specifically, in this embodiment, the heating layer is a nano coating. That is, the nano coating is directly applied (via printing or other processes) onto a side surface of the main tube to form the nano coating, and the nano coating generates heat when energized. In this case, the coated heating tube 622 is a nano-coated heating tube.

In another embodiment, the heating layer may alternatively be a printed circuit layer. That is, the printed circuit is directly applied (via printing or other processes) onto a side surface of the main tube to form the printed circuit layer, and the printed circuit layer generates heat when energized.

Both the side wall of the coated heating tube 622 and the side wall of the connecting water pipe 630 are fitted onto the ironing base plate 610, and the ironing base plate 610 is a heat conduction plate. On one hand, this can improve heating utilization efficiency of the coated heating tube 622; on the other hand, with such a structural setting, the overall volume of the steam generation apparatus is smaller. In addition, with such a structural setting, the coated heating tube 622 can directly heat the ironing base plate 610, so that dry ironing can be implemented when no water is injected into the heat conduction water pipe 624.

With reference to the accompanying drawings, specifically, an end, farther away from the heat conduction water pipe 624, of the connecting water pipe 630 is a flat structure 632, a flat surface of the flat structure 632 is fitted onto the ironing base plate 610, and a through hole 6301 fitting the steam outlet 6101 is disposed in the flat surface of the flat structure 632.

Preferably, in this embodiment, the heat conduction water pipe 624 is a metal pipe. The metal pipe has advantages such as excellent thermal conductivity, low costs, and ease of processing.

Specifically, with reference to the accompanying drawings, in this embodiment, the connecting water pipe 630 further includes a U-shaped connecting section 634, and the U-shaped connecting section 634 is connected to the heat conduction water pipe 624 and the flat structure 632 respectively.

Specifically, with reference to the accompanying drawings, in this embodiment, the heat conduction water pipe 624 and the connecting water pipe 630 are integrally formed metal pipes.

In this embodiment, there is one heat conduction water pipe 624.

In another embodiment, there are at least three heat conduction water pipes 624, the at least three heat conduction water pipes 624 are all sleeved inside the coated heating tube 622, and an end, closer to the connecting water pipe 630, of each of the at least three heat conduction water pipes 624 and the connecting water pipe 630 communicate. With such a configuration, a diameter of the heat conduction water pipe 624 can be significantly reduced, so that the blocking structure 6202 is easily disposed inside the heat conduction water pipe 624 and the blocking structure 6202 disposed inside the heat conduction water pipe 624 can better function.

Preferably, the blocking structure 6202 is a granular or filamentous blocking object filled inside the heat conduction water pipe 624, and/or the blocking structure 6202 is a concave-convex structure disposed on the inner wall of the heat conduction water pipe 624.

With reference to FIG. 10, in this embodiment, the blocking structure 6202 is a granular blocking object filled inside the heat conduction water pipe 624. In another embodiment, the blocking structure 6202 may alternatively be a filamentous blocking object filled inside the heat conduction water pipe 624.

The blocking structure 6202 not only blocks flowing of water, but also reduces a volume of water that can be accommodated inside the heat conduction water pipe 624 when being disposed in the heat conduction water pipe 624, thereby further ensuring sufficient heating.

More preferably, in this embodiment, the blocking object is metal particles or metal wires. The metal particles or metal wires have good thermal conductivity and low costs, and are less difficult to process.

When the blocking structure 6202 is a concave-convex structure disposed on the inner wall of the heat conduction water pipe 624, the blocking structure 6202 can enable water to form eddy currents inside the heat conduction water pipe 624, thereby reducing a flow velocity of water.

Preferably, in this embodiment, a filter screen (not shown in the figure) is further disposed at an end, closer to the connecting water pipe 630, of the heat conduction water pipe 624.

The filter screen can prevent the blocking object from leaking out of the heat conduction water pipe 624.

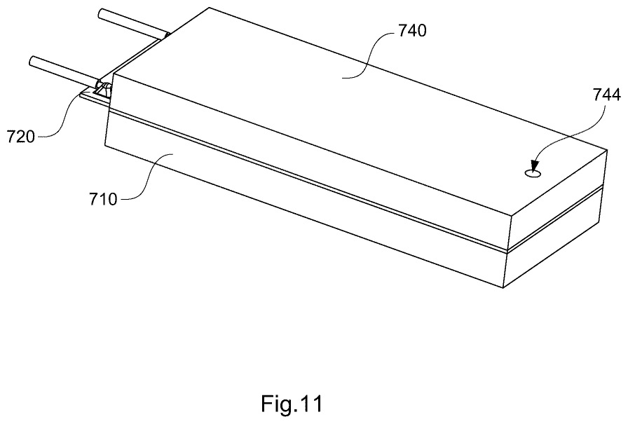

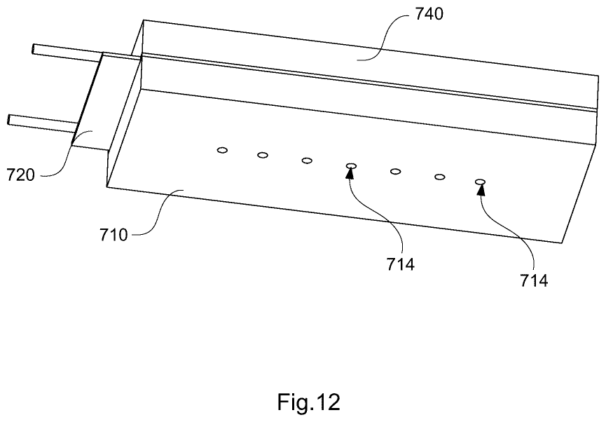

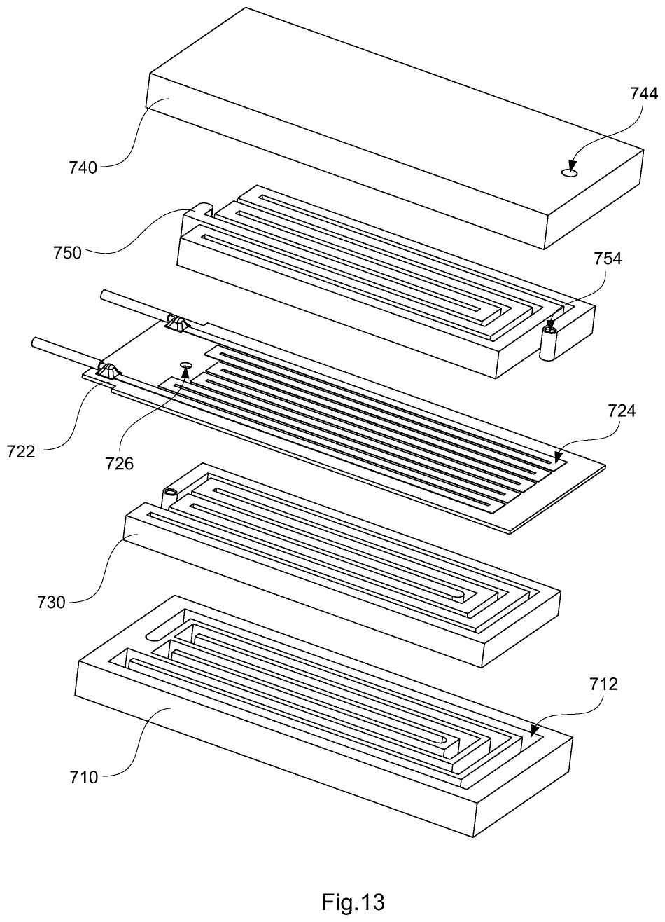

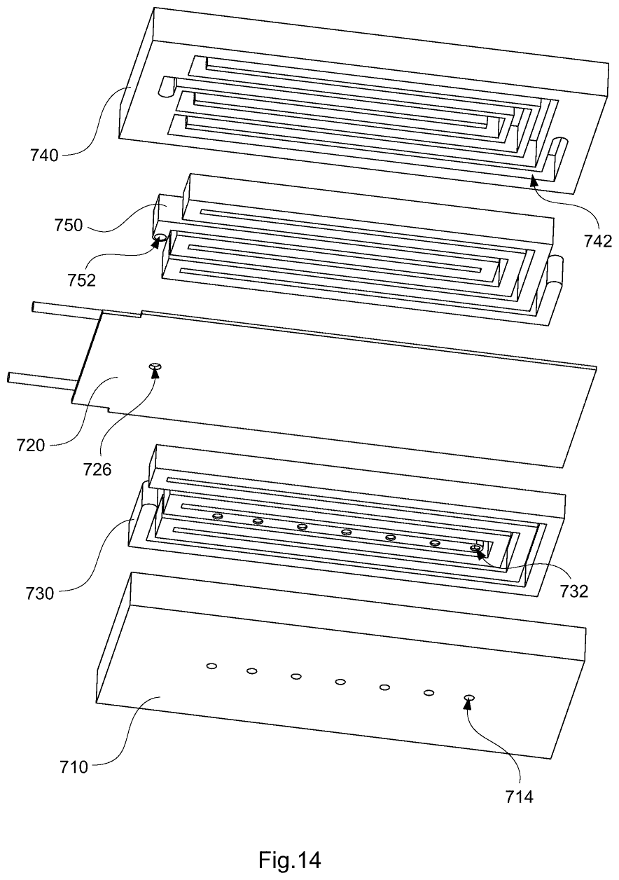

With reference to FIG. 11 to FIG. 14, the present invention discloses a steam generation apparatus according to an embodiment, including an ironing base plate 710 and a heating plate 720 stacked and fixed on the ironing base plate 710, where the heating plate 720 includes a heat conduction substrate 722 and a heating circuit layer 724 disposed on the heat conduction substrate 722.

A first flow channel 712 is disposed in a surface, closer to the heating plate 720, of the ironing base plate 710, multiple steam outlets 714 penetrating through the ironing base plate 710 are disposed at an end of the first flow channel 712, and the ironing base plate 710 and the heating plate 720 enclose a first cavity matching a shape of the first flow channel 712.

The steam generation apparatus in the present invention includes the heating plate 720 and the ironing base plate 710 stacked and fixed together. The ironing base plate 710 and the heating plate 720 enclose a first cavity matching a shape of the first flow channel 712. After being injected, water can be heated into steam by the heating plate 720.

Compared with conventional steam generation apparatuses, the steam generation apparatus in the present invention uses the heating plate 720 for heating. The heating plate 720 and the ironing base plate 710 are stacked. In addition, because the heating plate 720 is thinner than conventional electric heating tubes, an overall volume of the steam generation apparatus in the present invention is smaller.

Specifically, in this embodiment, the heating circuit layer 724 (similar to a heating film) having a function of generating heat when energized is directly fixed onto the heat conduction substrate 722, to form the heating plate 720. When the heating plate 720 is working, the heating circuit layer 724 generates heat upon energization.

It should be noted that in this case, the ironing base plate 710 and the heating plate 720 can form a complete steam generation apparatus. With reference to the accompanying drawings, the communication port 726 in the heating plate 720 can serve as an inlet for water flow (that is, a water inlet) at this time.

In another embodiment, the water inlet can also be disposed in the side surface of the ironing base plate 710.

Preferably, in this embodiment, the heating circuit layer 724 is disposed on a surface, farther away from the ironing base plate 710, of the heat conduction substrate 722.

The heating circuit layer 724 is disposed on the surface, farther away from the ironing base plate 710, of the heat conduction substrate 722, which can prevent the heating circuit layer 724 from coming into direct contact with water. In addition, with such a configuration, after the heating circuit layer 724 generates heat, the heat is conducted through the heat conduction substrate 722, which allows the heat to be distributed more uniformly.

With reference to the accompanying drawings, in this embodiment, an end of the first flow channel 712 is located in a central area of the ironing base plate 710, so that the steam outlet 714 is located in the central area of the ironing base plate 710 for user convenience.

Preferably, with reference to the accompanying drawings, in this embodiment, the steam generation apparatus further includes a first water pipe 730 disposed in the first cavity, the first water pipe 730 is accommodated in the first flow channel 712, multiple first outlets 732 matching the multiple steam outlets 714 are disposed at a tail end of the first water pipe 730, and the multiple first outlets 732 are corresponding to and communicate with the multiple steam outlets 714. A first inlet 734 matching the water inlet (communication port 726) is disposed at a head end of the first water pipe 730, and the first inlet 734 and the water inlet (communication port 726) communicate.

It should be noted that in this case, the ironing base plate 710, the heating plate 720 and the first water pipe 730 can form a complete steam generation apparatus. With reference to the accompanying drawings, the communication port 726 in the heating plate 720 can serve as an inlet for water flow at this time.

Preferably, with reference to the accompanying drawings, in this embodiment, the steam generation apparatus further includes a back plate 740, and the back plate 740, the heating plate 720 and the ironing base plate 710 are sequentially stacked and fixed together.

A second flow channel 742 is disposed in a surface, closer to the heating plate 720, of the back plate 740, a communication port 726 is disposed in the heat conduction substrate 722, the second flow channel 742 and the first flow channel 712 communicate through the communication port 726, the back plate 740 and the heating plate 720 enclose a second cavity matching a shape of the second flow channel 742, and a water inlet 744 penetrating through the back plate 740 is disposed at the head end of the second flow channel 742.

More preferably, with reference to the accompanying drawings, in this embodiment, in addition to a first water pipe disposed in the first cavity, the steam generation apparatus further includes a second water pipe 750 disposed in the second cavity, the first water pipe 730 is accommodated in the first flow channel 712, the second water pipe 750 is accommodated in the second flow channel 742, and the water inlet 744, the second water pipe 750, the communication port 726, the first water pipe 730 and the steam outlet 714 communicate in sequence.

Specifically, with reference to the accompanying drawings, a first inlet 734 is disposed in a surface, facing toward the heating plate 720, of the head end of the first water pipe 730, a second outlet 752 is disposed in a surface, facing toward the heating plate 720, of a tail end of the second water pipe 750, and the first inlet 734, the communication port 726 and the second outlet 752 communicate in sequence.

Specifically, to ensure airtightness, an adhesive can be disposed at a joint of the first inlet 734, the communication port 726 and the second outlet 752.

Multiple first outlets 732 matching the multiple steam outlets 714 are disposed at a tail end of the first water pipe 730, and the multiple first outlets 732 are corresponding to and communicate with the multiple steam outlets 714.

Specifically, in this embodiment, the water inlet 744 is located in a surface, farther away from the heating plate 720, of the back plate 740, a second inlet 754 is disposed in a surface, farther away from the heating plate 720, of a head end of the second water pipe 750, and the second inlet 754 and the water inlet 744 communicate.

In particular, in this embodiment, the back plate 740, the heating plate 720, the ironing base plate 710, the first water pipe 730 and the second water pipe 750 are all metal parts.

The metal parts have good thermal conductivity and low costs, and are less difficult and costly to process.

Specifically, in this embodiment, the metal parts are aluminum parts or aluminum alloy parts.

The steam generation apparatus in the present invention can be applied to multiple types of equipment and different fields, for example, the ironing field.

In the description of the embodiments of the present invention, it should be noted that the orientations or positional relationships indicated by the terms “center”, “longitudinal” “transverse”, “upper”, “lower”, “front”, “rear”, “left”, “right”, “perpendicular”, “horizontal”, “top”, “bottom”, “inside”, “outside”, and the like are based on the orientations or positional relationships shown in the accompanying drawings. These terms are merely for ease and brevity of the description of the embodiments of the present invention rather than indicating or implying that the apparatuses or elements mentioned must have specific orientations, or must be constructed or manipulated according to specific orientations, and therefore cannot be construed as any limitations on embodiments of the present invention. Further, the terms “first”, “second”, and “third” are used for descriptive purposes only and are not to be construed as indicating or implying relative importance.

In the description of the embodiments of the present invention, it should be noted that unless otherwise specified and defined explicitly, the terms “connect” and “join” should be interpreted broadly. For example, the terms may refer to a fixed connection, a detachable connection, or an integral connection; may refer to a mechanical connection or an electric connection; or may refer to a direct connection or an indirect connection via an intermediate medium. The specific meanings of the foregoing terms in the embodiments of the present invention can be understood by those of ordinary skills in the art according to specific circumstances.

In the embodiments of the present invention, unless otherwise specified and defined explicitly, a first feature being “on” or “under” a second feature may mean that the first and second features are in direct contact, or the first and second features are in indirect contact through an intermediate medium. Further, the first feature being “on”, “above”, or “on top of” the second feature may mean that the first feature is directly above or obliquely above the second feature, or simply mean that the first feature is horizontally higher than the second feature. The first feature being “under”, “below”, or “beneath” the second feature may mean that the first feature is directly beneath or obliquely beneath the second feature, or simply mean that the first feature is horizontally lower than the second feature.

In the description of this specification, descriptions referring to the terms “an embodiment”, “some embodiments”, “an example”, “a specific example”, or “some examples” mean that a specific feature, structure, material or characteristic described with reference to the embodiment or example is included in at least one embodiment or example of the embodiments of the present invention. In this specification, illustrative expressions of these terms do not necessarily refer to the same embodiment or example. In addition, the specific feature, structure, material, or characteristic described may be combined in any suitable manner in any one or more of the embodiments or examples. In addition, without mutual conflict, those skilled in the art may incorporate and combine different embodiments or examples and features of the different embodiments or examples described in this specification.

Finally, it should be noted that the foregoing embodiments are merely intended for describing the technical solutions of the present invention, but not for limiting the present invention. Although the present invention is described in detail with reference to the foregoing embodiments, those of ordinary skills in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A steam generation apparatus, comprising a cover plate, a heating body, a heating element, a heat conduction plate and an ironing base plate;
the heating element is connected to the heating body, the heating body comprises a cylindrical side wall and a partition structure, the partition structure divides the cylindrical side wall into a first annular side wall connected to the cover plate and a second annular side wall connected to the ironing base plate, and the partition structure, the first annular side wall and the cover plate enclose a first cavity;
the heat conduction plate is disposed inside the heating body, an outer circumference of the heat conduction plate is connected to an inner wall of the second annular side wall, the partition structure, the second annular side wall and the heat conduction plate enclose a second cavity, and the heat conduction plate, the second annular side wall and the ironing base plate enclose a third cavity; and
the cover plate is provided with an inlet communicating with the first cavity, the partition structure is provided with a first through hole connecting the first cavity to the second cavity, the heat conduction plate is provided with a second through hole connecting the second cavity to the third cavity, and the ironing base plate is provided with an outlet communicating with the third cavity.

2. The steam generation apparatus according to claim 1, wherein a step is disposed on the inner wall of the second annular side wall and the heat conduction plate is disposed on the step.

3. The steam generation apparatus according to claim 2, wherein the step is in an annular shape to match the outer circumference of the heat conduction plate.

4. The steam generation apparatus according to claim 3, wherein the outer circumference of the heat conduction plate and the step are fixed and sealed together via an adhesive.

5. The steam generation apparatus according to claim 4, wherein the heat conduction plate is a metal plate.

6. The steam generation apparatus according to claim 1, wherein a first flow channel is disposed on a surface, facing toward the cover plate, of the partition structure, and the inlet and the first through hole correspond to two openings of the first flow channel respectively.

7. The steam generation apparatus according to claim 6, wherein a second flow channel is disposed on a surface, facing toward the heat conduction plate, of the partition structure, and the first through hole and the second through hole correspond to two openings of the second flow channel respectively.

8. The steam generation apparatus according to claim 7, wherein the heating body is an integrally formed die-cast part.

9. The steam generation apparatus according to claim 7, wherein the heating element is disposed inside the partition structure and the heating element and the heating body are integrally formed via die casting.

10. A steam generation apparatus, comprising an ironing base plate and a heating tube assembly and a connecting water pipe that are both disposed on the ironing base plate, wherein a water inlet is disposed at an end, farther away from the connecting water pipe, of the heating tube assembly, a steam outlet is disposed in the ironing base plate, and the heating tube assembly, the connecting water pipe and the ironing base plate communicate in sequence, so that the water inlet and the steam outlet communicate; and
the heating tube assembly comprises a coated heating tube, and a blocking structure is disposed inside the heating tube assembly, so that water flowing in through the water inlet is blocked by the blocking structure when flowing inside the heating tube assembly.

11. The steam generation apparatus according to claim 10, wherein the heating tube assembly further comprises a heat conduction water pipe, the coated heating tube is sleeved outside the heat conduction water pipe, the water inlet is disposed at an end, farther away from the connecting water pipe, of the heat conduction water pipe, and the heat conduction water pipe, the connecting water pipe and the ironing base plate communicate in sequence.

12. The steam generation apparatus according to claim 11, wherein a side wall of the coated heating tube and a side wall of the connecting water pipe are both fitted onto the ironing base plate and the ironing base plate is a heat conduction plate; and
the coated heating tube comprises a main tube and a heating layer disposed on an outer side of the main tube, the heating layer is in direct contact with the ironing base plate, and the heating layer is a nano coating or a printed circuit layer.

13. The steam generation apparatus according to claim 12, wherein an end, farther away from the heat conduction water pipe, of the connecting water pipe is a flat structure, a flat surface of the flat structure is fitted onto the ironing base plate, and a through hole fitting the steam outlet is disposed in the flat surface of the flat structure.

14. The steam generation apparatus according to claim 13, wherein the heat conduction water pipe is a metal pipe.

15. The steam generation apparatus according to claim 11, wherein there are at least three heat conduction water pipes, the at least three heat conduction water pipes are all sleeved inside the coated heating tube, and an end, closer to the connecting water pipe, of each of the at least three heat conduction water pipes and the connecting water pipe communicate.

16. The steam generation apparatus according to claim 11, wherein the blocking structure is a granular or filamentous blocking object filled inside the heat conduction water pipe, and/or the blocking structure is a concave-convex structure disposed on the inner wall of the heat conduction water pipe.

17. The steam generation apparatus according to claim 16, wherein the blocking object is metal particles or metal wires.

18. The steam generation apparatus according to claim 16, wherein a filter screen is further disposed at an end, closer to the connecting water pipe, of the heat conduction water pipe.

19. A steam generation apparatus, comprising an ironing base plate and a heating plate stacked and fixed on the ironing base plate, wherein the heating plate comprises a heat conduction substrate and a heating circuit layer disposed on the heat conduction substrate; and
a first flow channel is disposed in a surface, closer to the heating plate, of the ironing base plate, multiple steam outlets penetrating through the ironing base plate are disposed at an end of the first flow channel, and the ironing base plate and the heating plate enclose a first cavity matching a shape of the first flow channel.

20. The steam generation apparatus according to claim 19, wherein the heating circuit layer is disposed on a surface, farther away from the ironing base plate, of the heat conduction substrate, and an end of the first flow channel is located in a central area of the ironing base plate, wherein a water inlet is disposed in a side surface of the ironing base plate or in the heating plate, wherein the steam generation apparatus further comprises a first water pipe disposed in the first cavity, the first water pipe is accommodated in the first flow channel, multiple first outlets matching the multiple steam outlets are disposed at a tail end of the first water pipe, the multiple first outlets are corresponding to and communicate with the multiple steam outlets, a first inlet matching the water inlet is disposed at a head end of the first water pipe, and the first inlet and the water inlet communicate, wherein the steam generation apparatus further comprises a back plate, and the back plate, the heating plate and the ironing base plate are sequentially stacked and fixed together; and a second flow channel is disposed in a surface, closer to the heating plate, of the back plate, a communication port is disposed in the heat conduction substrate, the second flow channel and the first flow channel communicate through the communication port, the back plate and the heating plate enclose a second cavity matching a shape of the second flow channel, and a water inlet penetrating through the back plate is disposed at the head end of the second flow channel, wherein the steam generation apparatus further comprises a first water pipe disposed in the first cavity and a second water pipe disposed in the second cavity, the first water pipe is accommodated in the first flow channel, the second water pipe is accommodated in the second flow channel, and the water inlet, the second water pipe, the communication port, the first water pipe, and the steam outlet communicate in sequence, wherein a first inlet is disposed in a surface, facing toward the heating plate, of the head end of the first water pipe, a second inlet is disposed in a surface, facing toward the heating plate, of a tail end of the second water pipe, and the first inlet, the communication port and the second outlet communicate in sequence, wherein multiple first outlets matching the multiple steam outlets are disposed at a tail end of the first water pipe, and the multiple first outlets are corresponding to and communicate with the multiple steam outlets; and the water inlet is located in a surface, farther away from the heating plate, of the back plate, a second inlet is disposed in a surface, farther away from the heating plate, of a head end of the second water pipe, and the second inlet and the water inlet communicate.
